(19) United States
(12) Patent Application Publication
(10) Pub. No.: US 2011/0292304 A1
(43) Pub. Date: Dec. 1, 2011

(54) TELEVISION CABINET FRAME

(76) Inventor: JOEN-SHEN MA, TAIPEI (TW)

(21) Appl. No.: 12/789,827

(22) Filed: May 28, 2010

(51) Int. Cl. H04N 5/64

(52) U.S. Cl. 348/836; 348/E05.128

(57) ABSTRACT

A television cabinet frame includes a first U-shaped frame member, a second U-shaped frame member, a third U-shaped frame member, and a fourth U-shaped frame member, which are assembled together to form the television cabinet frame. The two ends of each of the first and third U-shaped frame members are configured to form axial holes. The two ends of each of the second and fourth U-shaped frame members are configured to form axial projections. The axial projections are fit into the axial holes to inter-connect the four U-shaped frame members together to form the television cabinet frame. Once completed, the television cabinet frame can be further added with external accessories, such as a front panel, foot members, suction cups, a rear panel, a top panel, and partition boards, to provide a structurally stable television cabinet.

### BACKGROUND OF THE INVENTION

1. Field of the Invention

The present invention relates to a television cabinet frame, and in particular to a television cabinet frame that is of a construction formed by inter-connecting four U-shaped frame members, whereby the frame can be readily and efficiently formed without using any tool, and then external accessories, such as a front panel, foot members, suction cups, a rear panel, a top panel, and partition boards can be attached to the frame to provide a structurally stable television cabinet.

2. The Related Arts

Furniture of various functions and structures is available in the market. Conventionally, most of the furniture structures are made of wooden materials. However, with the recently popularized green environmental conservationism, which asks for protection of forests and requires no lumbering of the woods, the furniture industry now turns to use of composite materials other than wood for manufacturing modern fashion pieces of furniture.

A major challenge associated with the use of composite materials to manufacture furniture is the difficulty in combining different materials together. This makes the manufacturing process complicated, leading to the increase of working hours and manufacturing costs. This is one of the primary concerns for the furniture industry in using composite materials to make furniture.

### SUMMARY OF THE INVENTION

The present invention aims to provide a frame for constructing a television cabinet, which effectively shortens the time required for assembling the television cabinet, simplifies the process of assembling the television cabinet, and reduces the costs for manufacturing the television cabinet.

Thus, an objective of the present invention is to provide a television cabinet frame, which is of a construction formed by inter-connecting four U-shaped frame members, whereby the frame can be readily and efficiently formed without using any tool, and then external accessories, such as a front panel, foot members, suction cups, a rear panel, a top panel, and partition boards can be attached to the frame to provide a structurally stable television cabinet.

Thus, the present invention aims to provide a label roll holder returning mechanism for a barcode printer, comprising at least one restoration roller, a coiled resilient element, at least two movable rails, and at least two label roll holding elements. The restoration roller is rotatably mounted to a bottom of the barcode printer and has a top portion forming a positive-movement engagement section. The coiled resilient element is received inside the restoration roller to provide a restoration force to the rotation of the restoration roller. The movable rails are set to the bottom of the barcode printer in a substantially parallel manner. Each movable rail has a surface forming at least one counterpart positive-movement engagement section engaging the positive-movement engagement section of the restoration roller. The label roll holding elements are arranged at a top of the barcode printer and are coupled to the movable rails respectively, whereby the label roll holding elements offer the function of outward separating from each other for removing and installing a roll of label and inward approaching each other to clamp and hold the label roll by means of the engagement between the restoration roller and the movable rails and the restoration force thereof. As such, a label roll holder returning mechanism featuring balanced force restoration is provided.

To realize the above objective, the present invention adopts the following technical solution.

The television cabinet frame of the present invention comprises a first U-shaped frame member, a second U-shaped frame member, a third U-shaped frame member, and a fourth U-shaped frame member, which are assembled together to form the television cabinet frame.

The four U-shaped frame members are preferably made of tubes and opposite ends of each tube are bent to form the U-shape.

The two ends of each of the first and third U-shaped frame members are configured to form axial holes.

The two ends of each of the second and fourth U-shaped frame members are configured to form axial projections.

To assemble, the axial projections are fit into the axial holes to inter-connect the four U-shaped frame members together, as illustrated in FIGS. 1 and 2 of the attached drawings, whereby the four U-shaped frame members can be readily assembled together to form the television cabinet frame without using any tool.

Since the four U-shaped frame members are simple in structure and can be assembled together to form the television cabinet frame by simply fitting the axial projections into the axial holes, an advantage of being efficient in assembling with reduced labor and time is realized.

After the television cabinet frame is completely assembled, external accessories, such as a front panel, foot members, suction cups, a rear panel, a top panel, and partition boards, can be attached to the completed television cabinet frame to provide a structurally stable television cabinet as illustrated in FIG. 4.

In practical applications, the accessories of the television cabinet can be modified to present for example different forms/configuration. For example, the front panel can be one that is configured as a regular U-shape illustrated in FIG. 4 of the attached drawings, or alternatively, the front panel can be set as an inverted U-shape. Similarly, the rear panel and the top panel can be of shapes or configurations other than those illustrated in FIG. 4. In this way, various television cabinets can be formed with the same television cabinet frame.

### BRIEF DESCRIPTION OF THE DRAWINGS

The present invention will be apparent to those skilled in the art by reading the following description of a preferred embodiment thereof, with reference to the attached drawings, wherein:

FIG. 1 is a perspective view of a television cabinet frame constructed in accordance with the present invention;

FIG. 2 is an exploded view of the television cabinet frame of the present invention;

FIG. 3 shows a television cabinet frame of the present invention to which accessories are partially mounted thereto; and

FIG. 4 shows a television cabinet frame of the present invention to which accessories are attached.

### DETAILED DESCRIPTION OF THE PREFERRED EMBODIMENT

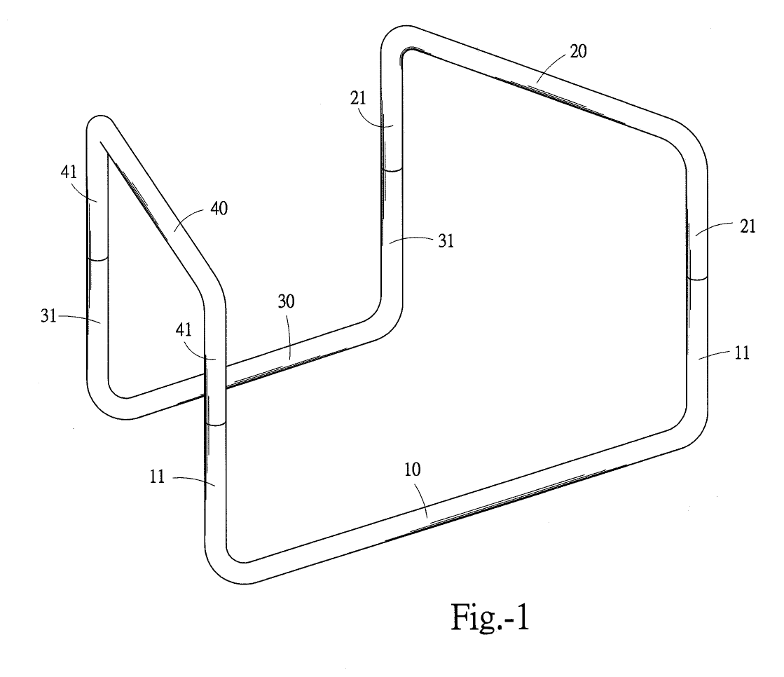

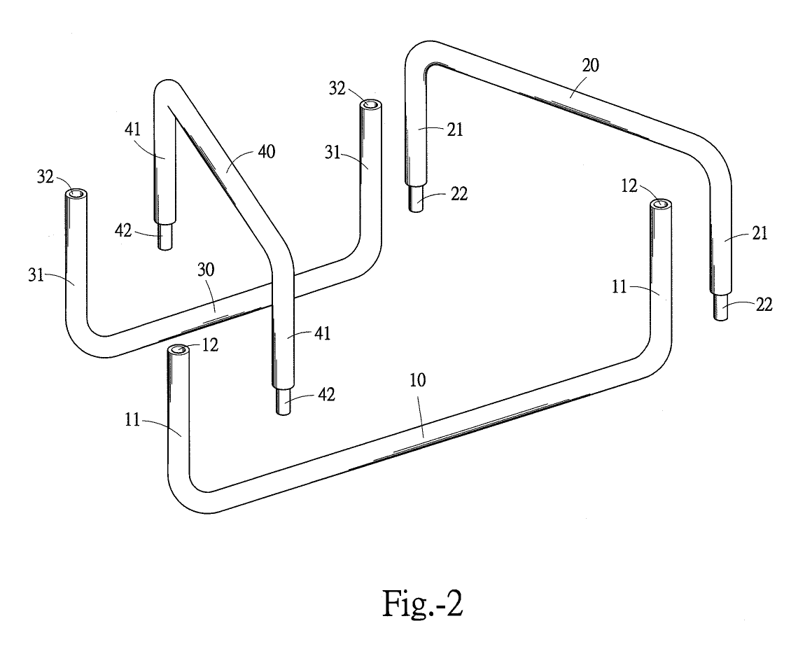

With reference to the drawings and in particular to FIGS. 1 and 2, which respectively show a perspective view of a television cabinet frame constructed in accordance with the present invention and an exploded view of the television cabinet frame of the present invention, the television cabinet frame of the present invention is comprised of a first U-shaped frame member 10, a second U-shaped frame member 20, a third U-shaped frame member 30, and a fourth U-shaped frame member 40.

The first U-shaped frame member 10 has two ends that are bent, preferably by a substantially right angle, to form bent branch sections 11. Each bent branch section 11 has a free end forming an axial hole 12.

The second U-shaped frame member 20 has two ends that are bent, preferably also by a substantially right angle, to form bent branch sections 21. Each bent branch section 21 has a free end forming an axial projection 22.

The third U-shaped frame member 30 has two ends that are bent, preferably also by a substantially right angle, to form bent branch sections 31. Each bent branch section 31 has a free end forming an axial hole 32.

The fourth U-shaped frame member 40 has two ends that are bent, preferably also by a substantially right angle, to form bent branch sections 41. Each bent branch section 41 has a free end forming an axial projection 42.

To assemble the television cabinet frame, the first and third U-shaped frame members 10, 30 are set to face upward, and the second and fourth U-shaped frame members 20, 40 are set in an inverted fashion to face downward. The axial projections 22 of the two ends of the second U-shaped frame member 20 are respectively fit into one of the axial holes 12 of the first U-shaped frame member 10 and one of the axial holes 32 of the third U-shaped frame member 30. The axial projections 42 of the two ends of the fourth U-shaped frame member 40 are respectively fit into the other one of the axial holes 32 of the third U-shaped frame member 30 and the other one of the axial holes 12 of the first U-shaped frame member 10. The television cabinet frame as shown in FIG. 1 is so formed by assembling the first, second, third, and fourth U-shaped frame members 10, 20, 30, 40 together without the need of any tool.

Alternatively, the four U-shaped frame members can be structured in such away that the ends of the first and third U-shaped frame members 10, are provided with axial projections, while the ends of the second and fourth frame members 20, 40 each form an axial hole. Or, further alternatively, each of the U-shaped frame member can form an axial projection on one of the ends thereof and form an axial hole in the other one of the ends thereof. Both alternative constructions do not affect the above discussed easy assembling of the television cabinet frame in accordance with the present invention.

The bent branch sections 21 of the second U-shaped frame member 20 is spaced by a distance that corresponds to a distance by which the bent branch sections 41 of the fourth U-shaped frame member 40 are spaced from each other.

In the embodiment illustrated in FIG. 1, for the case that the distance between the bent branch sections 11 of the first U-shaped frame member 10 is greater than the distance between the bent branch sections 31 of the third U-shaped frame member 30, the television cabinet frame can still be formed by readily assembling the U-shaped frame members 10, 20, 30, 40, but an external configuration of the television cabinet frame so formed is changed.

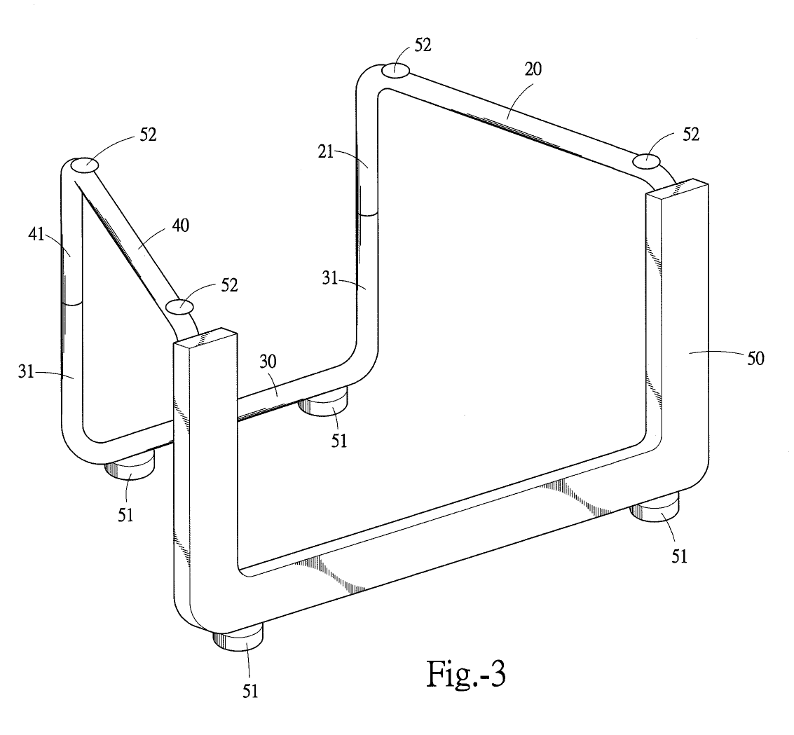

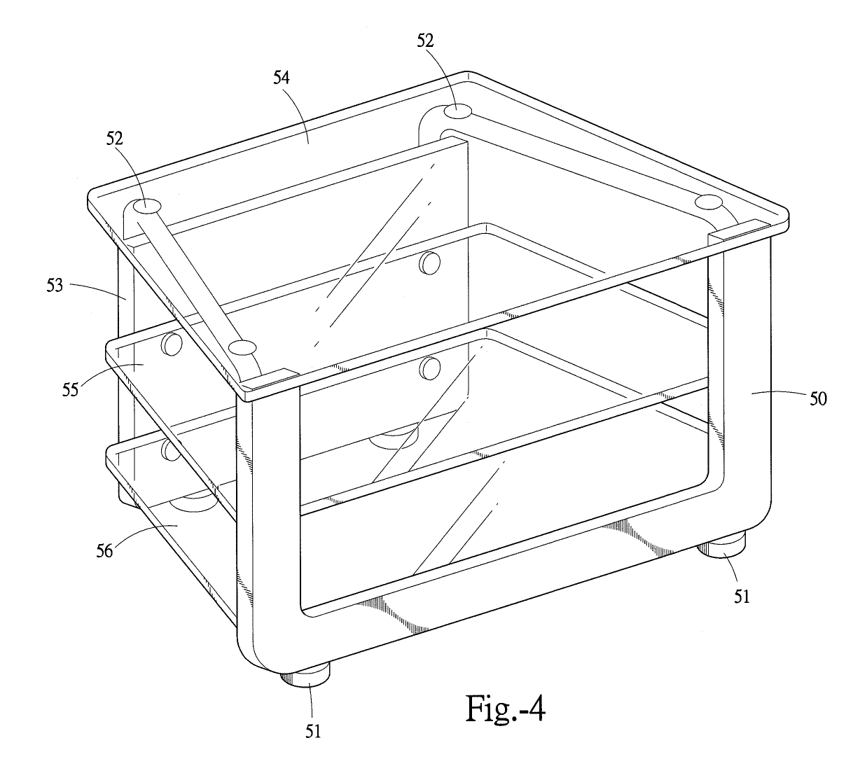

Also referring to FIGS. 3 and 4, which respectively show a television cabinet frame of the present invention which is partially finished and a completely finished television cabinet frame of the present invention, the television cabinet frame so assembled as illustrated above may then added with accessories, such as a front panel 50, foot members 51, suction cups 52, a rear panel 53, a top panel 54, and partition boards 55, 56, to form a structurally stable television cabinet, as best seen in FIG. 4.

In practical applications, the accessories of the television cabinet can be modified to present for example different forms/configuration. For example, the front panel 50 can be one that is configured as a regular U-shape illustrated in FIG. 4, or alternatively, the front panel 50 can be set as an inverted U-shape. Similarly, the rear panel 53 and the top panel 54 can be of shapes or configurations other than those illustrated in FIG. 4. In this way, various television cabinets can be formed with the same television cabinet frame.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A television cabinet frame, comprising:
a first U-shaped frame member having two ends bent to form bent branch sections, each bent branch section having a free end forming an axial hole;
a second U-shaped frame member having two ends bent to form bent branch sections, each bent branch section having a free end forming an axial projection;
a third U-shaped frame member having two ends bent to form bent branch sections, each bent branch section having a free end forming an axial hole; and
a fourth U-shaped frame member having two ends bent to form bent branch sections, each bent branch section having a free end forming an axial projection;
wherein to assemble, the first and third U-shaped frame members are set to face upward and the second and fourth U-shaped frame members are set in an inverted fashion to face downward, the axial projections of the two ends of the second U-shaped frame member being respectively fit into one of the axial holes of the first U-shaped frame member and one of the axial holes of the third U-shaped frame member, the axial projections of the two ends of the fourth U-shaped frame member being respectively fit into the other one of the axial holes of the third U-shaped frame member and the other one of the axial holes of the first U-shaped frame member, whereby the television cabinet frame is so formed by assembling the first, second, third, and fourth U-shaped frame members together.

2. The television cabinet frame as claimed in claim 1 further comprising a front panel, foot members, suction cups, a rear panel, a top panel, and partition boards, which are attached to the U-shaped frame members to provide a structurally stable frame.

3. The television cabinet frame as claimed in claim 1, wherein the bent branch sections of the second U-shaped frame member is spaced by a distance that corresponds to a distance by which the bent branch sections of the fourth U-shaped frame member are spaced from each other.

4. The television cabinet frame as claimed in claim 1, wherein the bent branch sections of the first U-shaped frame member is spaced by a distance that corresponds to a distance by which the bent branch sections of the third U-shaped frame member are spaced from each other.

5. The television cabinet frame as claimed in claim 1, wherein the bent branch sections of the first U-shaped frame member is spaced by a distance that is greater than a distance by which the bent branch sections of the third U-shaped frame member are spaced from each other.
